(19) United States
(12) Patent Application Publication
(10) Pub. No.: US 2003/0093807 A1
(43) Pub. Date: May 15, 2003

(54) Channel metaphor for TV system

(75) Inventor: Nga Marie Nguyen, Carlsbad, CA (US)

Correspondence Address: Rogitz & Associates, Suite 3120, 750 B Street, San Diego, CA, 92101, US

(73) Assignee: SONY CORPORATION, Tokyo (JP)

(21) Appl. No.: 09/991,541

(22) Filed: Nov. 15, 2001

(51) Int. Cl. H04N 7/173; H04N 7/16

(52) U.S. Cl. 725/109; 725/110; 725/25

(57) ABSTRACT

A TV system includes TV station channels and non-TV station signals that are dynamically assigned channel numbers, just as TV station signal frequencies are, by a TV service provider. The non-TV station signal channels are treated just as the TV station channels are, and possess all the properties of the TV station channels, such as ratings, lock-outs, etc.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. With the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean-back experience, it is desirable that a viewer be able to surf both TV channels and Web sites using a TV remote control device. It is further desirable that the presentation appear to be seamless to the viewer, that is, that a Web site appear as a channel on the TV, and have the same attributes as TV channels, including features such as rating and lock-out of a channel based on the rating for particular viewers. Moreover, it is sometimes the case that the TV signal provider will change the channel number associated with a particular station, and it is desirable that in the context of providing Web page channels, the channel number that is associated with a Web page is not hard-wired but rather can be changed in the same manner as a TV channel. Indeed, the present invention more broadly recognizes that TV channel metaphors be provided not only for Web pages but for virtually any service, such as TV system set up services, game services, and so on.

### SUMMARY OF THE INVENTION

Accordingly, a TV system that receives TV station signals and non-TV station signals such as Web sites, computer and game services, and so on is disclosed in which the channel numbers assigned to TV station frequencies/non-TV station signals can be dynamically established by the TV service provider. Indeed, both TV station signal channels and non-TV signal channels have the same properties, including lock-out, rating assignments, “favorite” status, etc.

In one aspect a system for presenting televised and non-televised content on a TV includes a TV and a channel metaphor device coupled to the TV. The channel metaphor device receives signals from a television signal provider, and some of the signals originate at television stations and are associated with respective channel numbers. Also, some of the channels can be non-television station signals each having an associated channel number. The channel numbers associated with the television stations and the channel numbers associated with the non-television station signals are dynamically established by the television signal provider. Accordingly, some of the signals from the television signal provider from time to time indicate changes in channel numbers including changes in the channel numbers associated with the non-television station signals.

In a preferred non-limiting embodiment, the non-television station signal is a Web page from the internet. In other aspects, the non-television station signal is a service selected from the group including but not limited to television set up services, game services, music services, and computer input device simulation services. Channels that are associated with non-television station signals can be associated with ratings that can be used to selectively display the non-television station signals. Specifically, based on ratings, channels can be locked-out by a user of the system, who can also designate a non-television station signal as a “favorite” channel using an input device. The input device can be a TV remote control user input device. This device can be the only user input device associated with the TV, except for conventional channel, volume, and TV setting controls located on the housing of the TV.

In another aspect, a method for displaying TV station signals and non-TV station signals on a TV includes associating each signal with a respective channel number, and changing the channel number of at least the non-TV signal. The method also includes conveying information representative of a change in the channel number of the non-TV signal in a signal from a TV signal provider.

In yet another aspect, a computer program product has means for receiving a TV broadcast signal, and means for extracting from the TV broadcast signal at least one non-TV channel number and an associated channel identification. Means are provided for updating a local database that correlates channel numbers with associated channel identifications.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a flow chart of the overall logic; and

FIG. 3 is a flow chart of the logic for changing channels including accounting for channel metaphor ratings.

### DETAILED DESCRIPTION OF THE PREFERRED EMBODIMENTS

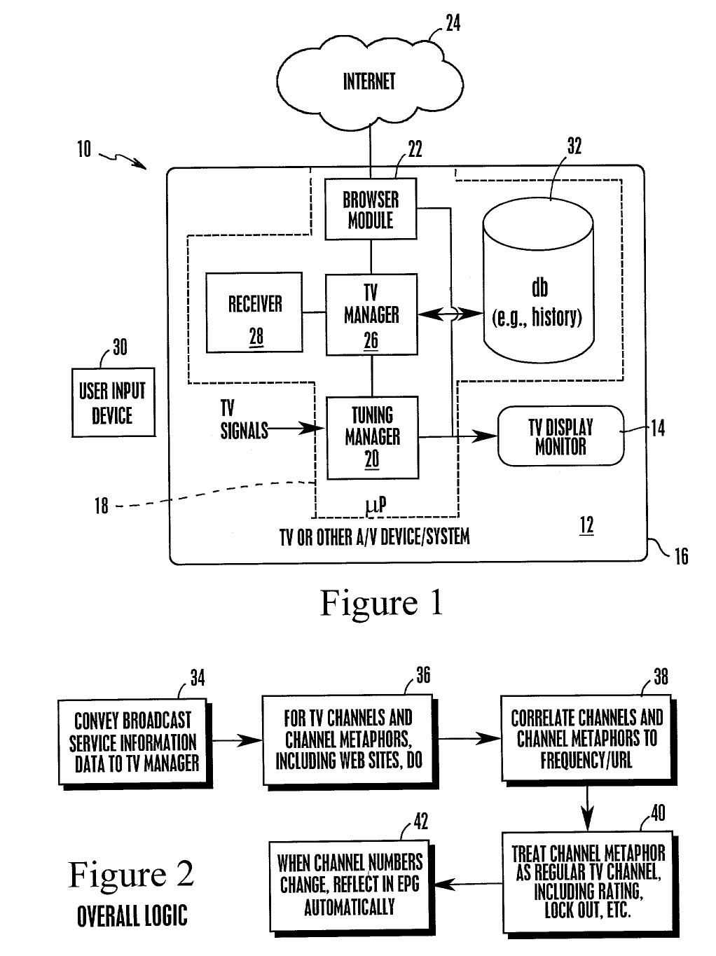

Referring initially to FIG. 1, a system is shown, generally designated 10. As shown, the system 10 includes a TV or other audio/video device 12 that conventionally receives televised content from an antenna, satellite dish, set-top box, etc. for display of the content on a monitor 14 that is supported in a housing 16. If desired, a processing module 18 can be incorporated into the housing 16 to function in accordance with the disclosure herein.

It is to be understood, however, that the term “television” or “television system” encompasses any apparatus that has a television tuner and the below-described capability in a single housing or in separate housings that cooperate together. For instance, the processing module 18 can be incorporated into a set top box that is electrically connected to the TV 12 but separate from the housing 16. The term “TV” or “TV system” encompasses such a configuration. Or, the module 18 can be incorporated into a personal video recorder (PVR) that functions in accordance with the present invention, or even into a standalone computer such as a PC or laptop with its own monitor (not shown), and can communicate with the TV 12 by wired or wireless link or simply by transferring data from the TV to the computer.

In the preferred non-limiting embodiment shown, the module 18 may be embodied by a processor that accesses one or more software elements to undertake the present logic, and consequently the module 18 can be thought of as a channel metaphor device. These elements can include a tuning manager 20 for receiving TV station signals from a cable, antenna, or other source as provided by a TV service provider. A browser 22 accesses the Internet 24 and presents Web pages on the display 14, and a TV manager 26 coordinates the various activities of the system 10. It is to be understood that greater or fewer software elements can be provided. For instance, the tuning manager 20, Web browser 22, and TV manager 26 can be integrated together as a single software module.

Additionally, the processing module 18 can include a receiver 28 for conventionally receiving control signals from a portable remote control device 30 that functions in accordance with principles known in the art. It is to be understood that while FIG. 1 shows that the device 30 can be a conventional TV remote control device, less preferably other devices can be used, such as but not limited to keyboards, keypads, mice, touch screen technology, voice activation/recognition technology, etc. Conventional channel, volume, and TV settings buttons (not shown) can also be provided on the housing 16. Moreover, a local data storage 32 preferably is included in conjunction with the processing module 18.

The processor of the processing module 18 accesses the tuning manager 20, browser module 22, and TV manager 26 to execute the logic set forth herein. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to the logic diagram shown in FIG. 2, at block 34 broadcast service information data is conveyed to the processing module 18. Part of this data sets forth channel numbers for TV station frequencies and for non-TV station services, such as but not limited to Web site URLs. Other non-limiting examples of non-TV station signals include services such as TV set up programs, game services that might be broadcast over a channel, broadcast music services, and computer services such as a service that, if the respective channel number is tuned to, presents an image of a computer keyboard, with keyboard functionality being provided based on inputs from the remote control device 30.

Accordingly, the channel number correlation to TV station frequencies and to Web site URLs is not hard-wired into the TV 12, but can be dynamically established by the TV service provider. Consequently, at block 36 a DO loop can be entered wherein channel numbers assigned to a particular TV station frequency or Web site URL can change from time to time as determined by the TV service provider, with the system 10 storing correlations of channel numbers to TV station frequencies, Web site URLs, and other non-TV station services in the data storage 32 at block 38.

Proceeding to block 40, non-TV signal channels, which can be regarded as “channel metaphors”, are treated from the viewer's standpoint as regular TV station channels. This includes providing the ability to rate Web site channels just like viewers can rate TV station channels in the more advanced digital TV systems. Also, Web site channels can be locked out for certain viewers based on the ratings. Other advanced features that are available or might become available for TV station channels are also applied to the channel metaphors. These additional features might include allowing a parent/system administrator to establish purchasing limits for a particular channel. Additional features can also include designating a channel metaphor as a “favorite” as stored in the data storage 32, so that it will be included in a favorite list along with favorite TV station channels. As indicated above, when the broadcast service information data indicates that one or more TV station frequencies or non-TV station signals (such as represented by, e.g., a Web site URL) have been assigned new channel numbers, at block 42 the new channel numbers are stored in the data storage 32 and are reflected in the electronic program guide (EPG) that can be presented in accordance with EPG principles known in the art on the display 14.

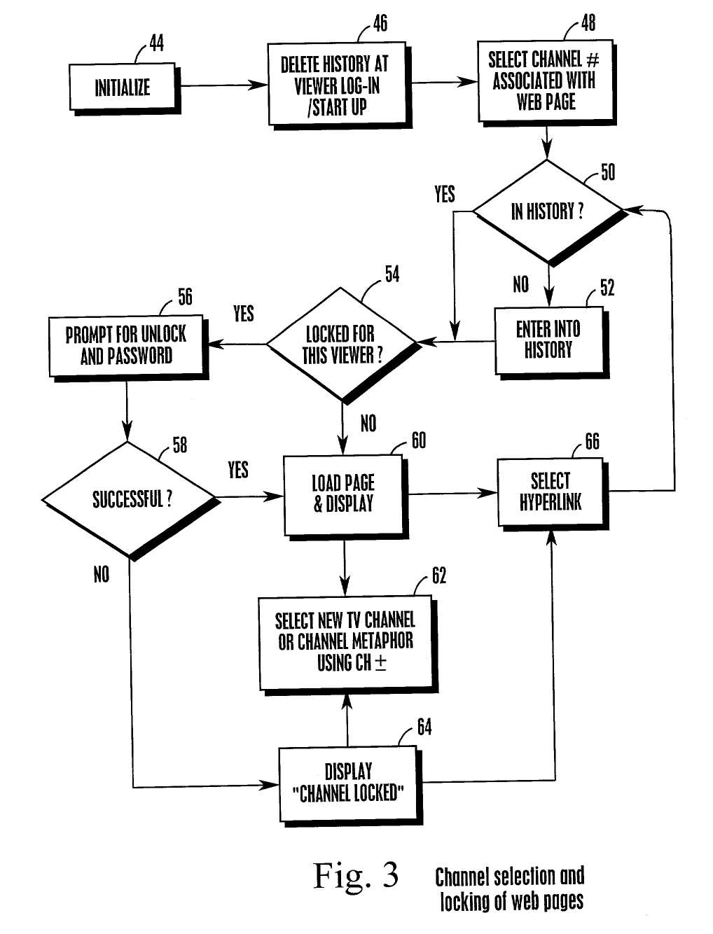

More specific logic is shown in FIG. 3. Commencing at block 44, the program initializes by, among other things, receiving a viewer identification and/or password of a viewer wishing to watch the TV. Moving to block 46 a “history” file in the data storage 32 is deleted upon initialization or when a new viewer logs on to the TV 12. At block 48, a viewer can manipulate the remote 30 to select a channel.

Assuming for disclosure purposes that a channel metaphor associated with a Web page URL has been selected, the logic proceeds to decision diamond 50, wherein it is determined whether the Web page is in the history folder. If not, the selected page is placed into history at block 52. Then, at decision diamond 54 it is determined whether, for the particular viewer, the channel has been locked by a parent/administrator. This lock-out can be accomplished using the remote 30 for a particular Web page URL, with the lock out “following” the URL to an updated channel number that might be received at block 42 in FIG. 2. The lock out can be based on Web page ratings received in the Web pages themselves or from an administrator/parent deciding how to rate each page. Unrated pages can be locked out on the basis that they are unrated, if desired. Other properties of Web page URLs such as being entered as a “favorite” follow the URL to new channel numbers when such are assigned by the TV service provider.

If the channel metaphor has been locked, the logic, if desired, can move to block 56 to prompt for an “unlock” entry such as a password of an authorized viewer. If it is determined at decision diamond 58 that the password unlocks the channel, the Web associated with the URL that is correlated to the channel number in the data storage 32 is loaded and displayed at block 60. Likewise, if the original viewer is entitled to access the channel at decision diamond 54, the logic flows to block 60 to present the Web page. In the event of an unsuccessful unlock at decision diamond 58, however, a message can be displayed at block 64 that the channel is locked.

From blocks 60 and 64 the viewer can proceed along separate paths to blocks 62 and 66. At block 62, the viewer can select a new TV station channel or channel metaphor by appropriately manipulating the remote 30, e.g., by toggling the channel up and down buttons, to cause another channel to be displayed on the display monitor 14. If a new channel metaphor is selected at block 62, the above-described logic repeats beginning at decision diamond 50. Also, the viewer might select a hyperlink from the displayed page at block 66, in which case the logic loops back to decision diamond 50.

While the particular CHANNEL METAPHOR FOR TV SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

I claim:

1. A system for presenting television station content and non-television station content on a TV, comprising:
a TV; and
a channel metaphor device coupled to the TV, the channel metaphor device receiving signals from a television signal provider, wherein
at least some of the signals originate at television stations and are associated with respective channel numbers,
the channel metaphor device also receiving at least one non-television station signal having an associated channel number,
at least some of the channel numbers being associated with the television stations and at least the channel number being associated with the non-television station signal being dynamically established by the television signal provider, some of the signals from the television signal provider from time to time indicating changes in channel numbers including changes in the channel number associated with the non-television station signal.

2. The system of claim 1, wherein the non-television station signal is a Web page from the internet.

3. The system of claim 1, wherein the non-television station signal is a service selected from the group including television set up services, game services, music services, and computer input device simulation services.

4. The system of claim 1, wherein the channel associated with the non-television station signal is associated with at least one rating.

5. The system of claim 4, wherein the non-television station signal is selectively displayed on the TV based on the rating.

6. The system of claim 4, wherein a user of the system can prevent display of a channel associated with the non-television station signal based on the rating.

7. The system of claim 1, wherein the channel associated with the non-television station signal can be designated as a “favorite” channel using an input device.

8. The system of claim 1, further comprising a remote control user input device, the remote control user input device not being a computer keyboard and being the only user input device associated with the TV except for channel, volume, and TV setting controls located on a housing of the TV.

9. A method for displaying TV station signals and non-TV station signals on a TV, comprising:
associating each signal with a respective channel number;
changing the channel number of at least the non-TV signal; and
conveying information representative of a change in the channel number of the non-TV signal in a signal from a TV signal provider.

10. The method of claim 9, wherein the non-TV signal is a Web page from the internet.

11. The method of claim 9, wherein the non-TV signal is a service selected from the group including television set up services, game services, music services, and computer input device simulation services.

12. The method of claim 9, wherein the channel associated with the non-TV signal is associated with at least one rating.

13. The method of claim 12, comprising selectively displaying the non-TV signal on the TV based on the rating.

14. The method of claim 12, comprising allowing a user to prevent display of a channel associated with the non-TV signal based on the rating.

15. The method of claim 9, comprising designating as a favorite the channel associated with the non-TV signal using an input device.

16. The method of claim 9, further comprising controlling the TV using a remote control user input device, the remote control user input device not being a computer keyboard and being the only user input device associated with the TV except for channel, volume, and TV setting controls located on a housing of the TV.

17. The system of claim 1, wherein the channel metaphor device is embodied in the TV.

18. The system of claim 1, wherein the channel metaphor device is embodied in a set top box associated with the TV.

19. A computer program product comprising:
means for receiving a TV broadcast signal;
means for extracting from the TV broadcast signal at least one non-TV station channel number and an associated channel identification; and
means for updating a local database correlating channel numbers with associated channel identifications.

20. The computer program product of claim 19, wherein at least one channel identification is a Web page URL.

21. The computer program product of claim 19, comprising means for associating the non-TV channel number with a service selected from the group including television set up services, game services, music services, and computer input device simulation services.

22. The computer program product of claim 19, comprising means for associating the non-TV channel number with at least one rating.

23. The computer program product of claim 22, comprising means for selectively displaying a non-TV signal on the TV based on the rating.

24. The computer program product of claim 19, comprising means for designating as a favorite a non-TV signal using an input device.
